(19) United States
(12) Patent Application Publication
(10) Pub. No.: US 2010/0007215 A1
(43) Pub. Date: Jan. 14, 2010

(54) SOFT MAGNETIC SHEET, MODULE INCLUDING THE SHEET AND NON-CONTACT POWER TRANSMISSION SYSTEM INCLUDING THE MODULE

(75) Inventor: Sadakatsu Sakuma, Sendai-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: NEC TOKIN Corporation, Sendai-shi (JP)

(21) Appl. No.: 12/499,215

(22) Filed: Jul. 8, 2009

(30) Foreign Application Priority Data
Jul. 10, 2008 (JP) 2008-180583
Sep. 26, 2008 (JP) 2008-247346

(51) Int. Cl. H01F 38/14; H01F 3/10

(52) U.S. Cl. 307/104; 335/297

(57) ABSTRACT

A non-contact power transmission system comprises a power receiver and a power transmitter. The power transmitter includes a transmitter coil. The power receiver includes a module which comprises a coil sheet and a soft magnetic sheet stacked on the coil sheet. The coil sheet includes a receiver coil. Electric power is transmitted from the transmitter coil to the receiver coil. The soft magnetic sheet comprises a pair of insulation films and a soft magnetic member hermetically interposed between the insulation films.

### CROSS REFERENCE TO RELATED APPLICATIONS

An applicant claims priority under 35 U.S.C. §119 of Japanese Patent Application No. JP2008-180583 filed Jul. 10, 2008 and Japanese Patent Application No. JP2008-247346 filed Sep. 26, 2008.

### BACKGROUND OF THE INVENTION

This invention relates to a non-contact or contactless power transmission system based on electromagnetic induction between coils.

One of the non-contact or contactless power transmission systems comprises a power receiver and a power transmitter. The power receiver includes a receiver coil, while the power transmitter includes a transmitter coil. Without direct contact between the transmitter coil and the receiver coil, electric power is transmitted from the transmitter coil to the receiver coil on the basis of the electromagnetic induction caused therebetween. For example, such non-contact power transmission system is used in a power supply system for supplying electric power to an artificial heart. Other applicable arts are a power supply system for a hand-held device, an IC tag system, a battery charger system and so on.

Effective power transmission system is disclosed in JP-A 2003-45731, the contents of which are incorporated herein by reference. The disclosed power transmission system comprises two coils, i.e. a receiver coil and a transmitter coil, and a ferrite sheet. The ferrite sheet includes a plurality of soft magnetic ferrite chips and is arranged on an outside of one of the coils.

Recently, a non-contact power transmission system, especially a power receiver is required to have a low-profile. For the low-profile requirement, a soft magnetic sheet such as the above-mentioned disclosed sheet is also required to be thinned. However, a thin soft magnetic sheet may be breakable when a force is applied to the soft magnetic sheet; if the soft magnetic sheet is broken, magnetic powder is scattered from the broken sheet within/out of the power receiver. There is a need for a thin soft magnetic sheet which is used for a power receiver of a non-contact power transmission system and which can prevent scattering of magnetic power even when a force is applied to the soft magnetic sheet.

### SUMMARY OF THE INVENTION

One aspect of the present invention provides a soft magnetic sheet comprising a pair of insulation films and a soft magnetic member hermetically interposed between the insulation films.

Another aspect of the present invention provides a module which comprises the above-mentioned soft magnetic sheet and a coil sheet stacked on the soft magnetic sheet, the coil sheet comprising a coil.

Another aspect of the present invention provides a non-contact power transmission system which comprises a power receiver and a power transmitter, the power receiver comprising the above-mentioned module.

An appreciation of the objectives of the present invention and a more complete understanding of its structure may be had by studying the following description of the preferred embodiment and by referring to the accompanying drawings.

### BRIEF DESCRIPTION OF THE DRAWINGS

FIG. 1 is a cross-sectional view schematically showing a part of a non-contact power transmission system according to an embodiment of the present invention, wherein the non-contact power transmission system comprises a power transmitter and a power receiver.

FIG. 2A is a perspective view schematically showing a soft magnetic sheet of the power receiver of FIG. 1.

FIG. 2B is a perspective view schematically showing a part of the power receiver of FIG. 1, the power receiver including the soft magnetic sheet of FIG. 2A.

FIG. 3A is a perspective view schematically showing a modification of the soft magnetic sheet of FIG. 2A.

FIG. 3B is a perspective view schematically showing a modification of the power receiver of FIG. 2B, the power receiver including the soft magnetic sheet of FIG. 3A.

FIG. 4 is an exploded, perspective view schematically showing a modification of the power receiver of FIG. 1.

FIG. 5A is a cross-sectional view schematically showing a modification of the power receiver of FIG. 1

FIG. 5B is a cross-sectional view schematically showing another modification of the power receiver of FIG. 1.

FIG. 5C is a cross-sectional view schematically showing another modification of the power receiver of FIG. 1.

FIG. 6A is a cross-sectional view schematically showing a part of another modification of the power receiver of FIG. 1, wherein the illustrated part corresponds to the right part or the left part of FIG. 5B or FIG. 5C.

FIG. 6B is a cross-sectional view schematically showing a part of another modification of the power receiver of FIG. 1, wherein the illustrated part corresponds to the right part or the left part of FIG. 5B or FIG. 5C.

FIG. 7 is a cross-sectional view schematically showing a part of another modification of the power receiver of FIG. 1, wherein the illustrated part corresponds to the right part or the left part of FIG. 5B or FIG. 5C.

FIG. 8A is a perspective view schematically showing a modification of the soft magnetic sheet of FIG. 2A.

FIG. 8B is a perspective view schematically showing another modification of the soft magnetic sheet of FIG. 2A.

FIG. 8C is a perspective view schematically showing another modification of the soft magnetic sheet of FIG. 2A.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DESCRIPTION OF PREFERRED EMBODIMENTS

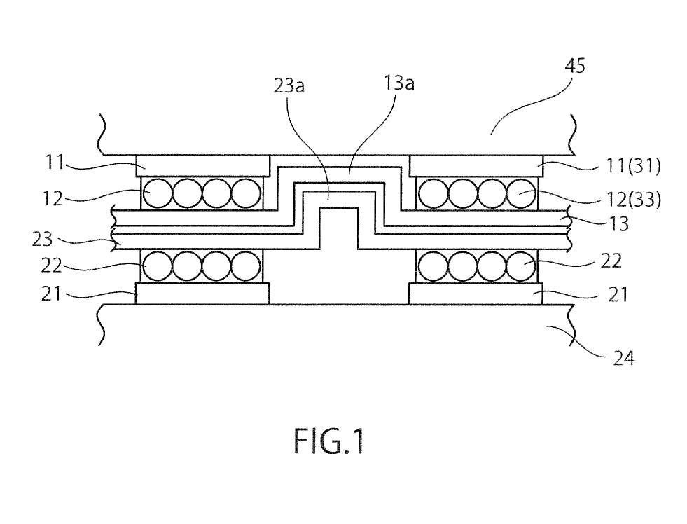

With reference to FIG. 1, a non-contact or contactless power transmission system according to an embodiment of the present invention comprises a power receiver 1 and a power transmitter 2.

The power receiver 1 comprises a soft magnetic sheet 11, a coil sheet 12, a receiver housing 13 and a circuit board 45. The soft magnetic sheet 11 is mounted on the circuit board 45. The coil sheet 12 is stacked on the soft magnetic sheet 11. The coil sheet 12 includes a receiver coil 33, as described later, which is connected to a circuit pattern formed on the circuit board 45. The receiver housing 13 is made of insulator and accommodates the soft magnetic sheet 11, the coil sheet 12 and the circuit board 45.

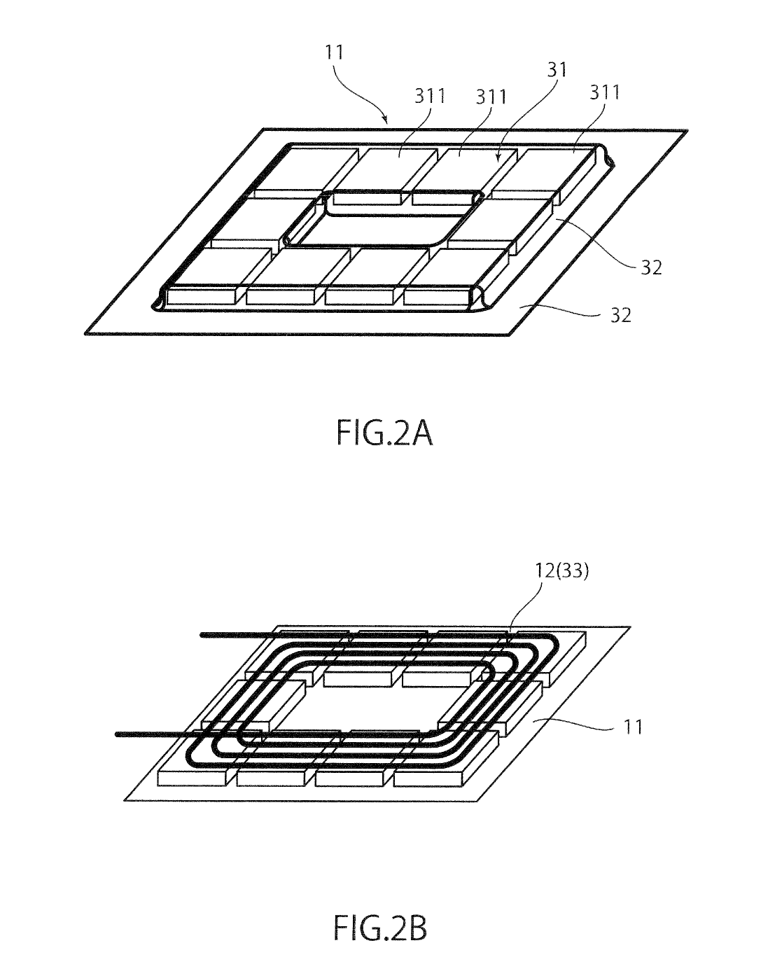

With reference to FIGS. 2A and 2B, the soft magnetic sheet 11 comprises a pair of insulation films 32 and a soft magnetic member 31, wherein the insulation films 32 are partially omitted in FIG. 2B for the sake of better understanding. The soft magnetic member 31 of the present embodiment is fixed between the insulation films 32. Specifically, the soft magnetic member 31 is hermetically interposed between the insulation films 32. In other words, the soft magnetic member 31 has a laminate structure. Each of the insulation films 32 is made of a polyester film. However, the present invention is not limited thereto. The insulation film 32 may be made of other materials.

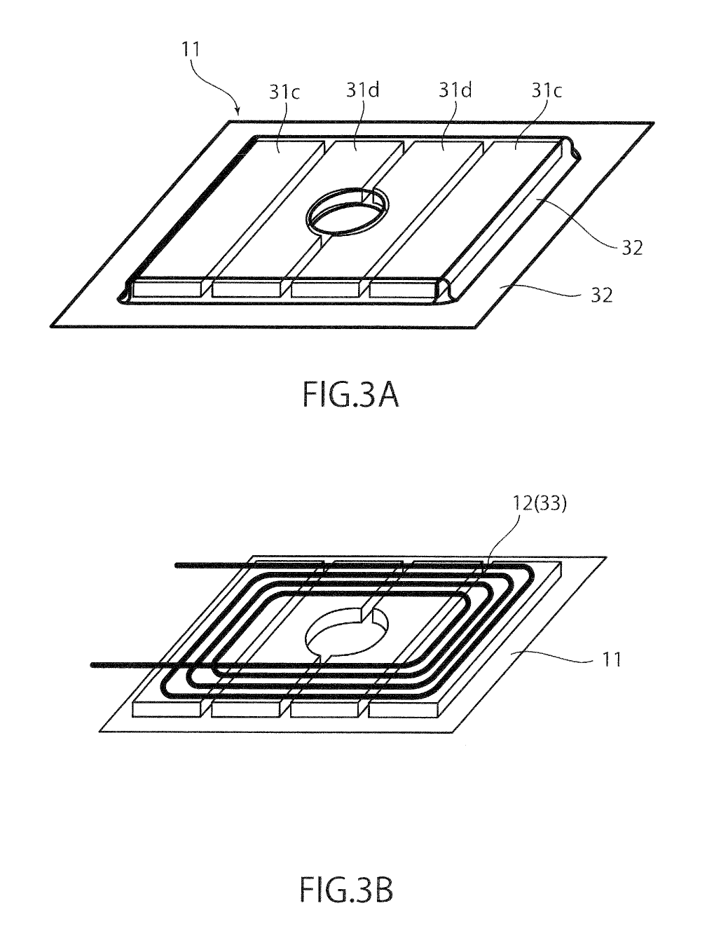

The soft magnetic member 31 of the present embodiment comprises ten soft magnetic pieces 311. Each of the soft magnetic pieces 311 has a small tile shape. However, the present invention is not limited thereto. The soft magnetic piece may have other shapes such as triangle and so on. In addition, the soft magnetic pieces 311 have the same shapes as each other. However, the present invention is not limited thereto. For example, as shown in FIGS. 3A and 3B, the soft magnetic member may be comprised of soft magnetic pieces 31c, 31d, wherein the insulation films 32 are partially omitted in FIG. 3B for the sake of better understanding. Each of the soft magnetic pieces 31c has a rectangular shape. Each of the soft magnetic pieces 31d has a similar shape to the soft magnetic piece 31c but is formed with a depression which generally has a half circle. The soft magnetic pieces 31d with depressions are arranged so as to form a circular depression which is positioned at a center section of the soft magnetic member. The depression may have any other shape.

The soft magnetic pieces 311 of the present embodiment are arranged in one layer so as to constitute a single loop so that the soft magnetic member 31 has a center section which does not contain any soft magnetic piece 311. At the center section, the insulation films 31 are directly fixed to each other. The insulation films 31 may be formed with an opening at the center section.

The coil sheet 12 comprises two insulation films and the receiver coil 33. The receiver coil 33 is hermetically interposed between the insulation films. In other words, the coil sheet 12 has a laminate structure so that the receiver coil 33 is insulated from the outside of the receiver coil 33 by the insulation films. The material of the receiver coil 33 of the present embodiment is a litz wire, but the present invention is not limited to a specific material. The coil sheet 12 is attached to the soft magnetic sheet 11 so that an inside area of the receiver coil 33 corresponds to the center section of the soft magnetic sheet 11, as apparent from FIG. 2B. The coil sheet 12 may have other structures. For example, the coil sheet may be formed as a printed circuit board in which a coil is printed on a substrate or board. The coil sheet may have a structure a discrete coil fixed on an insulation sheet. The coil sheet may consist of a discrete coil which is formed of turns of self-welding wire.

The receiver housing 13 is formed with a depression portion 13a. The depression portion 13a is positioned to correspond to the center section of the soft magnetic sheet 11. The depression portion 13a of the present embodiment has a rounded rectangular shape. However, the depression portion 13a may have any shape.

With reference to FIG. 1, the power transmitter 2 comprises a soft magnetic sheet 21, a coil sheet 22, a transmitter housing 23 and a circuit board 24 for supplying electric power. The soft magnetic sheet 21 has the same structure as the soft magnetic sheet 11. The coil sheet 22 has the same structure as the coil sheet 12, wherein the coil of the coil sheet 22 is used as a transmitter coil. However, the soft magnetic sheet 21 and/or the coil sheet 22 may have other structures. The transmitter coil is connected to a circuit pattern formed on the circuit board 24. The electric power is transmitted from the transmitter coil of the coil sheet 22 to the receiver coil 33.

The transmitter housing 23 is formed with a protuberant portion 23a which is fittable with the depression portion 13a. The protuberant portion 23a is positioned to correspond to the center section of the soft magnetic sheet 21. Upon the fitting of the protuberant portion 23a with the depression portion 13a, the receiver coil 33 and the transmitter coil are arranged to surround the protuberant portion 23a and the depression portion 13a, while the transmitter coil of the coil sheet 22 is positioned in correspondence with the receiver coil 33 of the coil sheet 12, as shown in FIG. 1. The positional correspondence between the receiver coil 33 and the transmitter coil enhances power transmission efficiencies. In this embodiment, the depression portion 13a is formed as a part of the receiver housing 13, while the protuberant portion 23a is formed as a part of the transmitter housing 23. Alternatively, the depression portion may be formed as a part of the transmitter housing 23, while the protuberant portion may be formed as a part of the receiver housing 13.

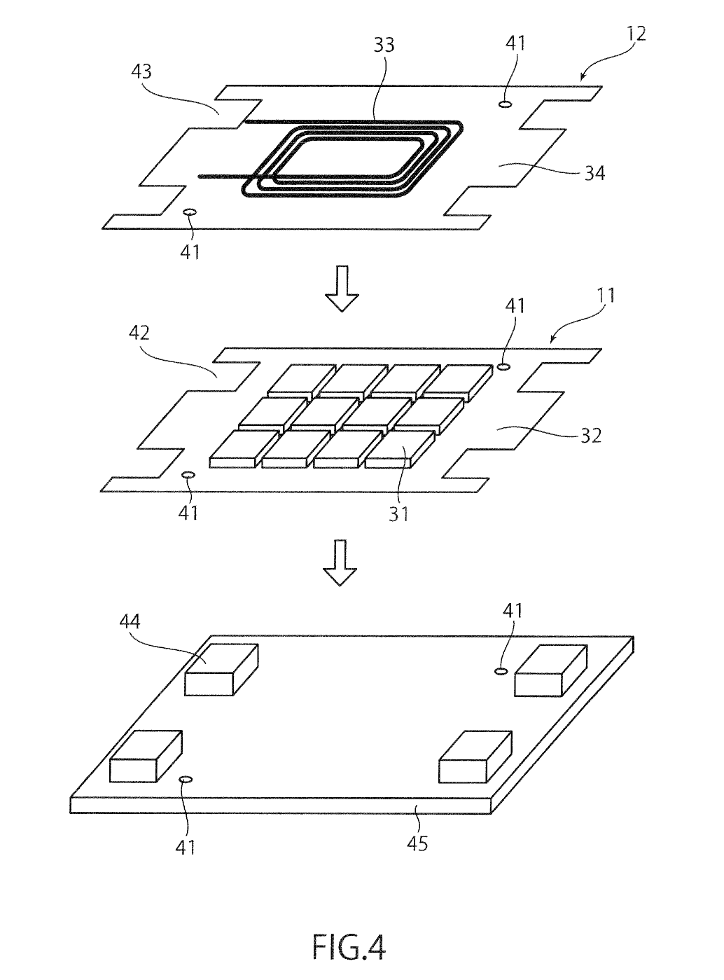

The power receiver 1 may be modified as shown in FIG. 4. The illustrated circuit board 45 is provided with positioning marks 41. The insulation films 32 of the soft magnetic sheet 11 are also provided with positioning marks 41. Likewise, the insulation films 34 of the coil sheet 12 are also formed with positioning marks 41. The positional correspondence among the positioning marks 41 provides a suitable stacking of the circuit board 45, the soft magnetic sheet 11 and the coil sheet 12. The positioning marks 41 may have any other shapes.

In this modification, the circuit board 45 is provided with electronic components 44. In consideration of the electronic components 44, the soft magnetic sheet 11 and the coil sheet 12 are provided with cut-off like portions 42, 43, respectively. Because of the cut-off like portions 42, 43, the soft magnetic sheet 11 and the coil sheet 12 are prevented from being undesirably bent when the soft magnetic sheet 11 and the coil sheet 12 are stacked on the circuit board 45.

In the above-mentioned embodiment, both of the power receiver 1 and the power transmitter 2 comprise the respective soft magnetic sheets 11, 21. Depending upon its used environment, any one of the power receiver 1 and the power transmitter 2 may comprise a soft magnetic sheet. However, it is preferable that the power receiver 1 comprises the soft magnetic sheet 11.

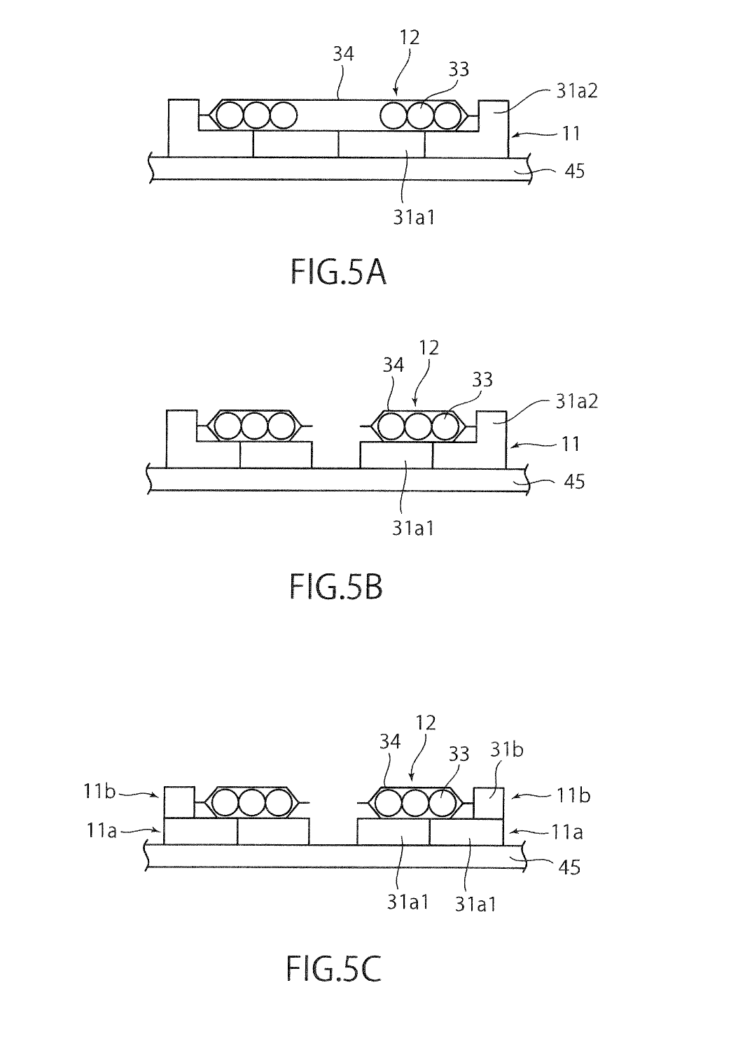

In the above-mentioned embodiment, the soft magnetic sheet comprises a uniform thickness of the soft magnetic member 31, and the number of the soft magnetic sheet is only one. However, the present invention is not limited thereto. For example, the soft magnetic sheet may have a mount portion and a surrounding portion, wherein the receiver coil of the coil sheet is mounted on the mount portion, and the surrounding portion has a thickness larger than another thickness of the mount portion. The non-uniform thickness of the soft magnetic sheet is embodied in for example FIGS. 5A to 5C. The soft magnetic sheet 11 of FIG. 5A comprises soft magnetic pieces 31a1 and soft magnetic pieces 31a2. Each of the soft magnetic pieces 31a1 has a uniform thickness. On the other hand, each of the soft magnetic pieces 31a2 has an L-shaped cross-section, i.e. a non-uniform thickness. The soft magnetic pieces 31a1 and the soft magnetic pieces 31a2 are arranged so that the soft magnetic sheet 11 has a thinner section and a thicker section, wherein the thinner section serves as the mount portion, while the thicker portion serves as the surrounding portion. The thicker portion, i.e. the surrounding portion enhances power transmission characteristics.

Although the soft magnetic sheet 11 of FIG. 5A does not have the above-mentioned center section, the soft magnetic sheet may have the center section even if the soft magnetic sheet has the surrounding portion. For example, the soft magnetic sheet 11 of FIG. 5B comprises soft magnetic pieces 31a1 and soft magnetic pieces 31a2 which are arranged so that the soft magnetic sheet 11 has a thinner section and a thicker section, similar to FIG. 5A. In addition, the soft magnetic sheet 11 of FIG. 5B is provided with the center section which does not contain any soft magnetic member. Furthermore, a similar structure of the soft magnetic sheet 11 may be formed of two soft magnetic sheets which have different shapes than each other, as shown in FIG. 5C. In FIG. 5C, each of the soft magnetic sheet 11a and the soft magnetic sheet 11b has a uniform thickness of the soft magnetic members. However, the soft magnetic member of the soft magnetic sheet 11b has a large aperture in comparison with the soft magnetic sheet 11a. Note here that the soft magnetic sheets of FIGS. 5A to 5C are schematically illustrated so that the insulation films 32 are not shown.

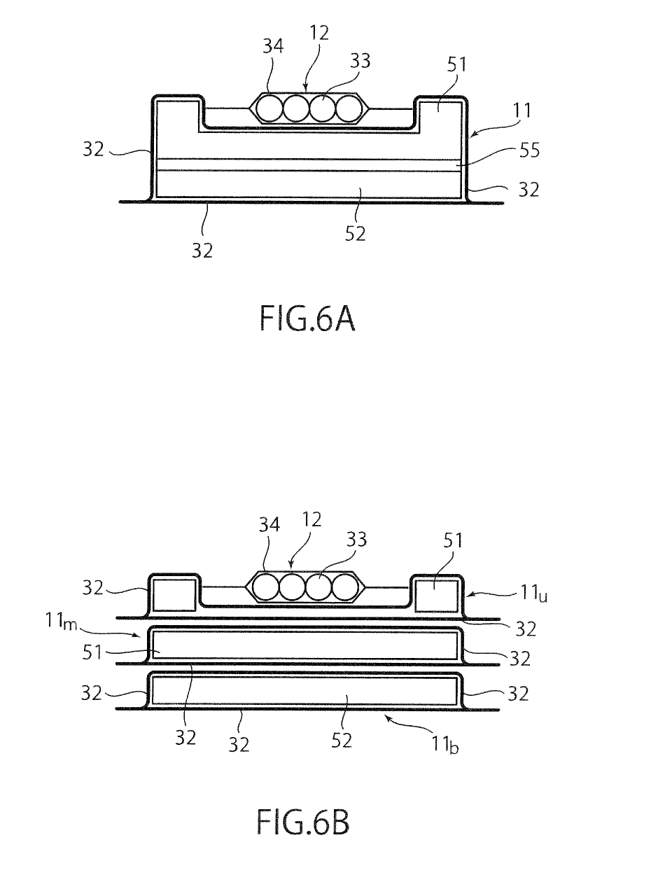

Instead of the soft magnetic pieces the soft magnetic sheet 11 may have one or more soft magnetic plate. For example, the soft magnetic sheet 11 of FIG. 6A comprises two soft magnetic plates 51 and 52, which are bonded together by using an adhesive agent 55. It is preferable that the adhesive agent 55 has a small Young's modulus and a small contractibility upon hardening process. The illustrated soft magnetic plates 51 and 52 are made of materials different from each other. The module of FIG. 6B comprises three soft magnetic sheets 11ᵤ, 11ₘ and 11_{b}. The upper soft magnetic sheet 11ᵤ has a frame shape. The middle soft magnetic sheet 11ₘ is made of a material same as that of the upper soft magnetic sheet 11ᵤ but has a normal plate-like shape. The bottom soft magnetic sheet 11_{b} is made of a material different from the middle soft magnetic sheet 11ₘ but has the same shape as the middle soft magnetic sheet 11ₘ. Note here that each of the modules of FIGS. 6A and 6B has a structure which has a thinner section and a thicker section similar to FIGS. 5A to 5B.

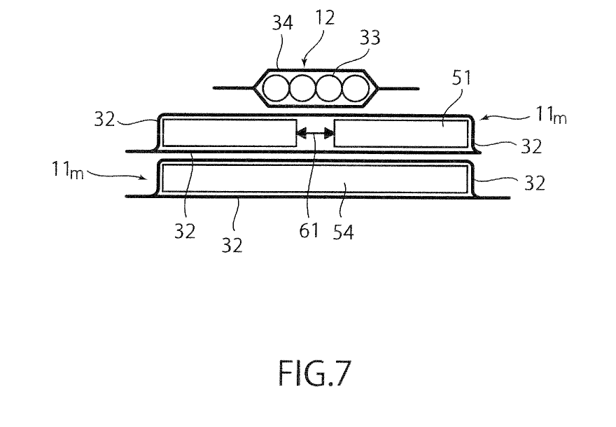

FIG. 7 shows another modification of the module. The module of FIG. 7 comprises two soft magnetic sheets 11_{g}, 11ₚ. The soft magnetic sheet 11ₚ has a normal sheet-like soft magnetic member 54. On the other hand, the soft magnetic sheet 11_{g} has a soft magnetic member 51 which is provided with a magnetic gap 61. The magnetic gap 61 is positioned just below the coil 33 so as to enhance the magnetic saturation characteristic of the module of FIG. 7. It is preferable that the soft magnetic member 51 has a large permeability such as ferrite or metallic soft magnetic material. The ferrite is for example Mn—Zn ferrite or Ni—Zn ferrite. The metallic soft magnetic material is for example sendust. The soft magnetic member 54 serves to prevent magnetic leakage. The soft magnetic member 54 is made of an electromagnetic interference suppression sheet which comprises sendust flakes dispersed and arranged into resin binder. The modification may be further modified in consideration of FIG. 6A. Specifically, the soft magnetic member 51 and the soft magnetic member 54 are bonded together, and the whole members 51, 54 are hermetically interposed between two insulation films 32.

Although the soft magnetic member 31 of the soft magnetic sheet 11 of FIG. 2A consists of the soft magnetic pieces 311 which are same as each other, the present invention is not limited thereto. The soft magnetic sheet may consist of two or more kinds of soft magnetic pieces, depending upon its used environment. In detail, if high insulation is required only in a particular region, soft magnetic pieces with higher insulation characteristic should be used for the particular region. For example, between Mn—Zn based ferrite and Ni—Zn based ferrite, Ni—Zn based ferrite should be used for the particular region; instead, Mn—Zn based ferrite may be used for the other region other than the particular region. Likewise, if heat generation components are arranged only on a specific region, soft magnetic pieces with higher Curie points should be used for the specific region. For example, between Mn—Zn based ferrite and Ni—Zn based ferrite, Ni—Zn based ferrite should be used for the specific region; instead, Mn—Zn based ferrite may be used for the other region other than the specific region.

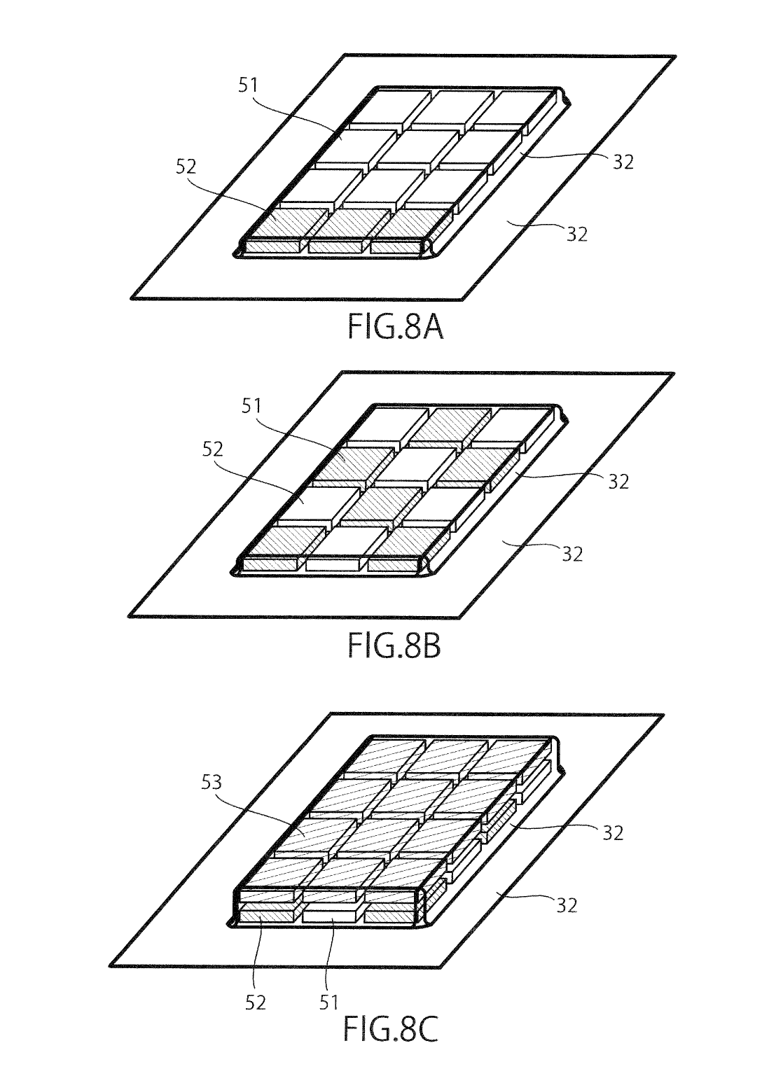

In FIG. 8A, two kinds of soft magnetic pieces 51, 52 are used. The soft magnetic pieces 52 are arranged only on one side edge; the other area are occupied by the other soft magnetic pieces 51. This is the case which has the particular region or the specific region as mentioned above. In FIG. 8B, two kinds of soft magnetic pieces 51, 52 are used but are arranged in a checkered flag pattern so that their magnetic characteristics are averaged. In addition, the soft magnetic sheet of FIG. 8C comprises two layers of soft magnetic pieces. In this embodiment, the number of the soft magnetic pieces of the upper layer is equal to the number of the soft magnetic pieces of the lower layer. In other words, the soft magnetic pieces belonging to the upper layer is equal in number to the soft magnetic pieces belonging to the lower layer. The lower layer comprises two kinds of soft magnetic pieces 51, 52 are used but are arranged in a checkered flag pattern, similar to FIG. 8B. The upper layer comprises one kind of soft magnetic pieces 53.

### Example 1

The non-contact power transmission system according to an example 1 was fabricated and evaluated. The present example 1 is based on FIGS. 1, 2A and 2B. Each of the soft magnetic pieces 311 was made of sintered spinelle ferrite which had permeability of about 2500 and saturation magnetization of about 0.5 T (5000 G). The size of each piece 311 is 11 mm×11 mm×1 mm. The insulation films 32 were made of polyester films. The soft magnetic sheet 21 had a structure same as the soft magnetic sheet 11. The receiver coil was formed of five turns of litz wire, which was formed of a bundle of ten copper-based self welding wires each having a diameter of 100 μm. The receiver coil had a rectangular loop shape which had an outer size of 35 mm×25 mm while having an inner size of 25 mm×15 mm; the thickness of the receiver coil was 1.5 mm. The receiver coil was interposed between the insulation films of polyester. The coil sheet 22 had a structure same as the coil sheet 12. The protuberant portion 23a had a shape of 3 mm×18.5 mm×8.5 mm, while the depression portion 13a had a shape of 3 mm×20 mm×10 mm. Under the conditions of frequency of 100 kHz and a primary voltage level of 4 V, a secondary voltage level P2 and its transformation efficiency η was evaluated, where η=(output power/input power)×100 (%). The evaluated secondary voltage level P2 was 8 W, while the evaluated transformation efficiency η was 58%. These evaluated values show good power transmission capability.

### Example 2

Similar evaluation was carried out for the case of FIGS. 3A and 3B. The soft magnetic piece 31c had a size of 35 mm×11 mm×1 mm. The half circle shaped depression of the soft magnetic piece 31d had a radius of 5 mm. The other conditions were same as those of the above-mentioned example 1. The evaluated secondary voltage level P2 was 8 W, while the evaluated transformation efficiency η was 59% These evaluated values show good power transmission capability.

### Example 3

Similar evaluation was carried out for the case of FIG. 5B. The thinner portion had a thickness of 1 mm. The thicker portion had a thickness of 2.5 mm. The other conditions were same as those of the above-mentioned example 1. The evaluated secondary voltage level P2 was 8 W, while the evaluated transformation efficiency η was 68%. As understood from the evaluation, the thicker portion enhances the transformation efficiency η.

### Example 4

Evaluation was carried out for the case of FIG. 7. The soft magnetic member 51 was made of Mn—Zn ferrite and had a shape of 11 mm×5 mm×1 mm. The magnetic gap 61 of the soft magnetic member 51 was 1 mm. The soft magnetic member 54 was made of an electromagnetic interference suppression sheet which comprised sendust power dispersed in resin binder. The magnetic gap 61 prevented magnetic saturation, while the electromagnetic interference suppression sheet prevented magnetic leakage. In addition, the soft magnetic sheet was allowed to have a radius of curvature of 30 mm.

The present application is based on Japanese patent applications of JP2008-180583 and JP2008-247346 filed before the Japan Patent Office on Jul. 10, 2008 and Sep. 26, 2008, respectively, the contents of which are incorporated herein by reference.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. A soft magnetic sheet comprising:
a pair of insulation films; and
a soft magnetic member fixed between the insulation films.

2. The soft magnetic sheet according to claim 1, wherein the soft magnetic member is hermetically interposed between the insulation films.

3. The soft magnetic sheet according to claim 1, wherein the soft magnetic member comprises two or more soft magnetic pieces.

4. The soft magnetic sheet according to claim 3, wherein the soft magnetic pieces are arranged in one layer.

5. The soft magnetic sheet according to claim 3, wherein the soft magnetic pieces are arranged in two or more layers, each of layers comprising two or more of the soft magnetic pieces.

6. The soft magnetic sheet according to claim 5, wherein the soft magnetic pieces belonging to one of the layers are equal in number to the soft magnetic pieces belonging to another one of the layers.

7. The soft magnetic sheet according to claim 3, wherein the soft magnetic pieces are grouped into at least two groups, the groups being made of materials different from each other.

8. The soft magnetic sheet according to claim 1, wherein the soft magnetic member comprises two or more soft magnetic plates which are stacked each other.

9. The soft magnetic sheet according to claim 8, wherein the soft magnetic plates are grouped into at least two groups, the groups being made of materials different from each other.

10. The soft magnetic sheet according to claim 2, including a center section which does not contain the soft magnetic member at which the insulation films are directly fixed to each other.

11. A module comprising the soft magnetic sheet according to claim 1 and a coil sheet stacked on the soft magnetic sheet, the coil sheet comprising a coil.

12. The module according to claim 11, wherein the coil sheet is a laminate structure comprising two films and the coil hermetically interposed therebetween.

13. The module according to claim 11, wherein the soft magnetic sheet including a mount portion and a surrounding portion, the coil being positioned on the mount portion, the surrounding portion having a thickness larger than another thickness of the mount portion.

14. A non-contact power transmission system comprising a power receiver and a power transmitter, the power receiver comprising the module according to claim 11.

15. The non-contact power transmission system according to claim 14, wherein: the power receiver comprises a receiver housing; the power transmitter comprises a transmitter housing; one of the receiver housing and the transmitter housing is provided with a protuberant portion, while a remaining one of the receiver housing and the transmitter housing is provided with a depression portion; and the protuberant portion is fit with the depression portion when the power transmitter transmits power to the power receiver.

16. The non-contact power transmission system according to claim 15, wherein the coil of the module serves as a receiver coil of the power receiver; the power transmitter includes a transmitter coil; the receiver coil and the transmitter coil are arranged to surround the protuberant portion and the depression portion.
